(19) United States
(12) Patent Application Publication
(10) Pub. No.: US 2007/0159665 A1
(43) Pub. Date: Jul. 12, 2007

(54) Scanning module and image reading apparatus having the scanning module installed therein

(75) Inventor: Jung-Kwon Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/592,171

(22) Filed: Nov. 3, 2006

(30) Foreign Application Priority Data
Jan. 6, 2006 (KR) 2006-1679

(51) Int. Cl. H04N 1/04

(52) U.S. Cl. 358/474

(57) ABSTRACT

Provided are a scanning module and an image reading apparatus having the same. An alignment unit that can align positions of an image sensor and its tilt angles with regard to five degrees of freedom when a coupling position of an alignment member to a frame and a coupling position of a base plate to the alignment member are controlled, is provided, the image sensor can be aligned regardless of whether or not the production of the scanning module is completed, an alignment process is facilitated, and a manufacturing cost is reduce.

### CROSS-REFERENCE TO RELATED APPLICATION

This application claims the benefit of Korean Patent Application No. 2006-1679, filed on Jan. 6, 2006, in the Korean Intellectual Property Office, the disclosure of which is incorporated herein in its entirety by reference.

### BACKGROUND OF THE INVENTION

1. Field of the Invention

Aspects of the present invention relate to a scanning module and an image reading apparatus having the scanning module installed therein, and, more particularly, to a scanning module including an integrally formed light source, mirror, lens and image sensor for document reading, and an image reading apparatus having the scanning module including the integrally formed light source, mirror, lens and image sensor for document reading installed therein.

2. Description of the Related Art

An image reading apparatus projects light to read an image from a document. Examples of image reading apparatuses include scanners, facsimiles, all-in-one (multifunction) devices, and the like.

In order to read a document in these apparatuses, either a scanning module or a document needs to be moved with respect to the other. An image reading apparatus with a movable scanning module is commonly called a flat-bed type image reading apparatus. As another concept, a sheet-feed type image reading apparatus is configured to move a document. A hybrid type image reading apparatus adopts both flat-bed type and sheet-feed type such that a flat-bed type image reading apparatus is provided with an auto document feeder (ADF). Except for the case of the sheet-feed type image reading apparatus, scanning modules are moved in a sub-scanning direction to read a document.

The image reading apparatus includes a flat glass panel which a document is placed on, and a scanning module disposed below the flat glass plate. Although a scanning module, in which an image sensor is separately fixed to a body of an image reading apparatus, has been proposed, hereinafter, scanning modules will be described as being limited to having an integrally formed light source, mirror, lens, and image sensor.

Light emitted from the light source proceeds toward the document. A large amount of this light is reflected from a blank space of the document where no image is printed on a document while only a small amount of light is reflected from a region where an image exists. Accordingly, image data printed on the document may be read depending upon differences in the amount of light reflected from the document. The light containing image data, by being reflected from the document, is reflected by a mirror provided within a scanning module and is transferred through an optical path until reaching a focusing lens. The light is then focused by the focusing lens and is made incident upon an image sensor. The light is then converted into an electric signal and then is received on a main board of the image reading apparatus.

The light source, the mirror, the focusing lens, and the image sensor are arranged to form the optical path and are fixed to a frame that forms an exterior of the scanning module. In order not to distort the optical path, those elements should be fixed at predetermined positions and predetermined tilt angles within the frame. If the optical path reaching the focusing lens from the light source via the mirror is distorted or the installation position and tilt angle of the image sensor are deviated from the predetermined value, defective image-reading may occur.

In general, those elements are separately prepared and are fixed to the frame by an adhesion member, a hardening agent, a coupling member, or the like. However, because some time is required to completely harden the adhesion member or the hardening agent, those elements may deviate from their desired positions while the adhesion member or the hardening agent is hardened. Although the fixing is made with the coupling member, slight position deviation may easily occur. Also, because tolerance in an assembling operation is accumulated in addition to the tolerance of an element unit itself, precise alignment of the optical path and the image sensor becomes more difficult as the number of elements involved in the assembly increases.

Even if those elements are precisely aligned in an operation of producing a scanning module, their alignment may be undesirably distorted if heat of the light source, vibration, or the like is applied thereto as the scanning module is repetitively used. Also, injection molding of the frame with a synthetic resin material may increase a level of distortion. If the image reading apparatus has a structure that makes after-correction of the alignment impossible, a scanning module with a defective alignment must be removed from the image reading apparatus causing inconvenience and increased costs.

### SUMMARY OF THE INVENTION

Aspects of the present invention provide scanning module and an image reading apparatus with the scanning module, the scanning module having an integrally-formed image sensor and requiring a small number of elements to be adjusted to adjust the alignment of the image sensor at any time.

According to an aspect of the present invention, there is provided a scanning module including: a frame in which a light source, a mirror and a focusing lens are disposed to form an optical path to read a document; a base plate to which an image sensor is attached, the image sensor receiving light focused by the focusing lens; an alignment member disposed between the focusing lens and the base plate; and an alignment unit aligning positions and tilt angles of the image sensor with regard to five degrees of freedom by controlling a coupling position of the alignment member with respect to the frame and a coupling position of the base plate with respect to the alignment member.

According to another aspect of the present invention, there is provided an image reading apparatus including a scanning unit reading a document using a scanning module, the scanning module including: a frame in which a light source, a mirror and a focusing lens are disposed to form an optical path to read a document; a base plate to which an image sensor is attached, the image sensor receiving light focused by the focusing lens; an alignment member disposed between the focusing lens and the base plate; and an alignment unit aligning positions and tilt angles of the image sensor with regard to five degrees of freedom by controlling a coupling position of the alignment member with respect to the frame and a coupling position of the base plate with respect to the alignment member.

The alignment unit may include: a first alignment unit, by controlling the coupling position of the alignment member to the frame, aligning the position of the image sensor in a sub-scanning direction and the tilt angle of the image sensor about a direction perpendicular to a surface of the document; and a second alignment unit, by controlling the coupling position of the base plate to the alignment member, aligning the position of the image sensor in a main scanning direction, the position of the image sensor in the direction perpendicular to the document surface, and the tilt angle of the image sensor about the sub-scanning direction.

The first alignment unit may include: a hinge provided at one of the frame and the alignment member, the hinge being a rotation axis of the alignment member rotating around the direction perpendicular to the document surface; a slot having a long hole shape and provided at the remaining one of the frame and the alignment member, and in which the hinge is inserted to be movable in the sub-scanning direction; a first fixing member to fix the alignment member to the frame; a first through hole provided at one of the frame and the alignment member and through which the first fixing member loosely penetrates; and a first coupling hole provided at the remaining one of the frame and the alignment member and to which the first fixing member is coupled.

The second alignment unit may include: a second fixing member to fix the base plate to the alignment member; a second through hole provided at one of the alignment member and the base plate and through which the second fixing member loosely penetrates; and a second coupling hole provided at the remaining one of the alignment member and the base plate and to which the second fixing member is coupled.

A diameter of the first through hole may be greater than a diameter of the first fixing member so as to allow the alignment member to move within an available range, and a diameter of the second through hole may be greater than a diameter of the second fixing member so as to allow the base plate to move within an available range.

The alignment unit may further include an elastic member elastically to bias the first and second fixing members in opposite directions to coupling directions of the first and second fixing members.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become more apparent and more readily appreciated from the following description of the embodiments, taken in conjunction with the accompanying drawings of which:

FIG. 1 is a perspective view that illustrates an exterior of an image reading apparatus according to an embodiment of the present invention;

FIG. 2 is a side sectional view of an image reading apparatus shown in FIG. 1;

FIG. 3 is a perspective view of a scanning unit shown in FIG. 1;

FIG. 4 is a side sectional view of a scanning module shown in FIG. 1;

FIG. 5 is an assembled perspective view of the scanning module shown in FIG. 1;

FIG. 6 is an exploded perspective view of the scanning module shown in FIG. 1; and

FIGS. 7 and 8 are views for explaining positions and tilt angles of an image sensor shown in FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

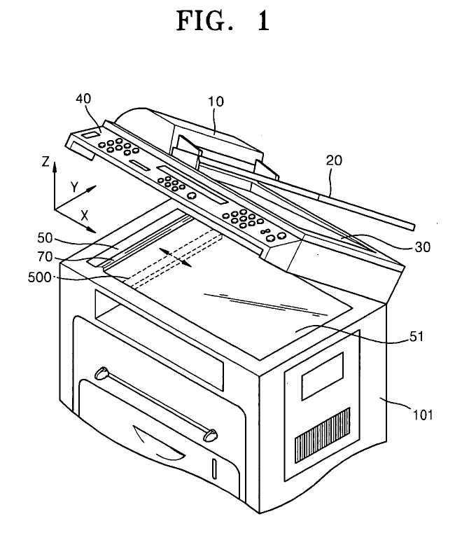

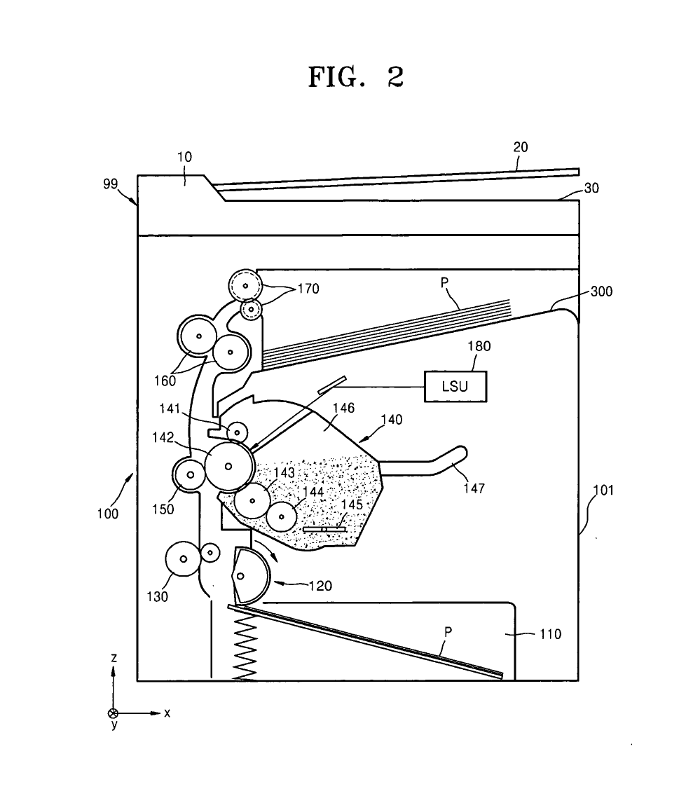

FIG. 1 is a perspective view that illustrates an exterior of an image reading apparatus according to an embodiment of the present invention, and FIG. 2 is a side sectional view of the image reading apparatus according to the present invention. The image reading apparatus includes a scanning unit 99 reading a document and may further include a printing unit 100 printing an image. As shown in both FIGS. 1 and 2, an all-in-one (multifunction) apparatus that may perform both scanning of a document and printing of an image is illustrated as one embodiment of the image reading apparatus. According to an embodiment of the present invention, the illustrated printing unit 100 prints an image by electrophotography. The scanning unit 99 is a hybrid type of apparatus, which has an auto document feeder (ADF) 10 to allow an image to be read in both flat-bed type methods and sheet-feet type methods.

The printing unit 100 includes an exposing unit 180, a developing unit 140, a fusing unit 160, and a document feeding cassette 110. The x direction is a sub-scanning direction in which a printable medium P and a document S are conveyed. The y direction is a main scanning direction perpendicular to the sub-scanning direction. The z direction is perpendicular to the surface of the document S. Although not shown, a printing unit 100 printing an image by an inkjet method or by a dye diffusion method is also possible as an embodiment of the present invention.

The exposing unit 180 emits light corresponding to image information onto a photoconductor 142 to thereby form an electrostatic latent image on an outer circumferential surface of the photoconductor 142.

The developing unit 140 is detachably mounted to the inside of a body 101 of the image reading apparatus. In an embodiment of the invention, the developing unit 140 includes a charge roller 141, a photoconductor 142, a developing roller 143, a supply roller 144, an agitator 145 and a toner storage unit 146. The toner storage unit 146 stores toner. The developing unit 140 is replaced when all of the toner stored in the toner storage 146 is exhausted. The developing unit 140 is mounted to the body 101 of the image reading apparatus when a handle 147 is pushed in the negative x direction of FIG. 2, and is detached from the body 101 of the image reading apparatus when the handle 147 is pulled in the positive x direction of FIG. 2.

The photoconductor 142 includes a cylindrical drum, an outer circumferential surface of which is coated with a photoconductive material by deposition or a similar method. Such a photoconductor 142 is rotatably installed with the outer circumferential surface thereof partially exposed. The photoconductor 142 is electrified to have a predetermined electric potential by the charge roller 141, and an electrostatic latent image corresponding to an image to be printed is formed on the outer circumferential surface thereof by light emitted from the exposing unit 180.

The developing roller 143 receives solid powder phase toner on a surface thereof and develops the electrostatic latent image as a toner image by allowing the toner to attach to the electrostatic latent image formed on the photoconductor 142. A developing bias voltage to supply the toner to the photoconductor 142 is applied to the developing roller 143. As the developing roller 143 and the outer circumferential surface of the photoconductor 142 come in contact with each other, a developing nip is formed therebetween, and as the developing roller 143 and the photoconductor 142 are spaced apart, a developing gap is formed therebetween. The developing nip and the developing gap should be formed uniformly with a predetermined size along an axial direction of the developing roller 143 and the photoconductor 142. Toner moves through the developing gap or the developing nip to perform the development of the image.

The supply roller 144 supplies toner so that the toner is attached to the developing roller 143. The agitator 145 agitates toner in order to prevent hardening of the toner within the toner storage 146 and conveys the toner toward the supply roller 144.

A transfer roller 150 faces the outer circumferential surface of the photoconductor 142 and receives a transfer bias voltage of opposite polarity to that of the toner image developed on the photoconductor 142 so as to allow the toner image to be transferred onto a printing medium P (i.e., paper, transparency, etc.). The toner image is transferred onto the printing medium P by an electrostatic force and mechanical contact pressure between the photoconductor 142 and the transfer roller 150.

The fusing unit 160 includes a heating roller and a pressing roller facing each other and fuses the toner image on the printable medium P by an application of heat and pressure to the toner image.

After the fusing of the image onto the printing medium P is completed, ejecting rollers 170 eject the printing medium P to an exterior of the image forming apparatus. The printing medium P, ejected from the printing unit 100, is then loaded in a media output tray 300.

A conveyance path of the printing medium P is as follows. The printing unit 100 includes the document feeding cassette 110 storing the printing medium P. A pick-up roller 120 picks up and draws out the printing medium Pstored in the document feeding cassette 110 one by one. Feed rollers 130 convey the picked-up printing medium P toward the developing unit 140. The printing medium P passes between the photoconductor 142 and the transfer roller 150 so that a toner image is transferred thereto. The printing medium P, to which the toner image has been transferred, is fused by heat and pressure of the fusing unit 160. The printing medium P, on which the fusion operation has been completely performed, is ejected to the media output tray 300 by the ejecting rollers 170.

The scanning unit 99 includes a scanning module 500 that scans a document S with light to read an image from the document S, first and second flat glass panels 50 and 51 on which the document S is moved or placed for the scanning module 500 to scan the document S, and the ADF 10, which automatically feeds the document S. The x direction is a sub-scanning direction in which the scanning module 500 moves, and the y direction is a main scanning direction in which the scanning module 500 reads an image from the document S.

The first flat glass panel 50 makes contact with a document S while the ADF 10 conveys the document S, and the second flat glass panel 51 makes contact with a document S placed thereon. The first flat glass panel 50 and the second flat glass panel 51 are separated from each other. A document guide member 70 having an inclined surface is provided between end portions of the first and second flat glass panels 50 and 51. The document guide member 70 guides a leading edge of the document S to a document output tray 30. The operational states of the printing unit 100 and the scanning unit 99 are displayed on a display panel 40, and various operation keys are provided to the display panel 40.

A document S loaded on a document feed tray 20 is conveyed to the first glass panel 50 by the ADF 10. While remaining below the first flat glass panel 50, the scanning module 500 reads an image from the document S. The read document S is ejected to the document output tray 30.

A document S which is supplied in a sheet by sheet sequence without using the ADF 10 is placed on an upper surface of the second flat glass panel 51. The scanning module 500 is conveyed to the underside of the second flat glass panel 51 in the sub-scanning direction to read an image from the stationary document S. The scanning module 500 reads a document S being supplied by the ADF 10 when placed below the first flat glass panel 50 and reads a stationary document S when placed below the second flat glass panel 51. Here, it is apparent that the scanning unit 99 may be embodied in various arrangements without being limited to the above-described arrangement or the illustration of FIG. 2.

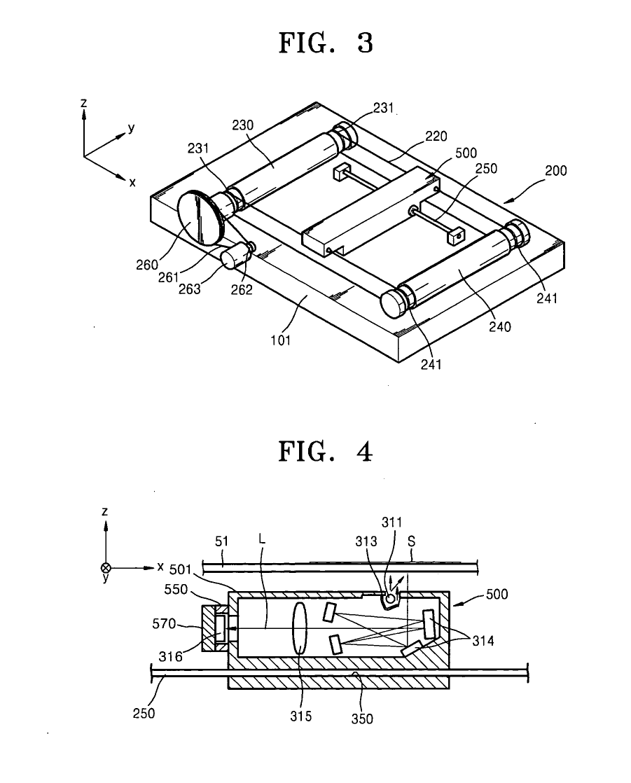

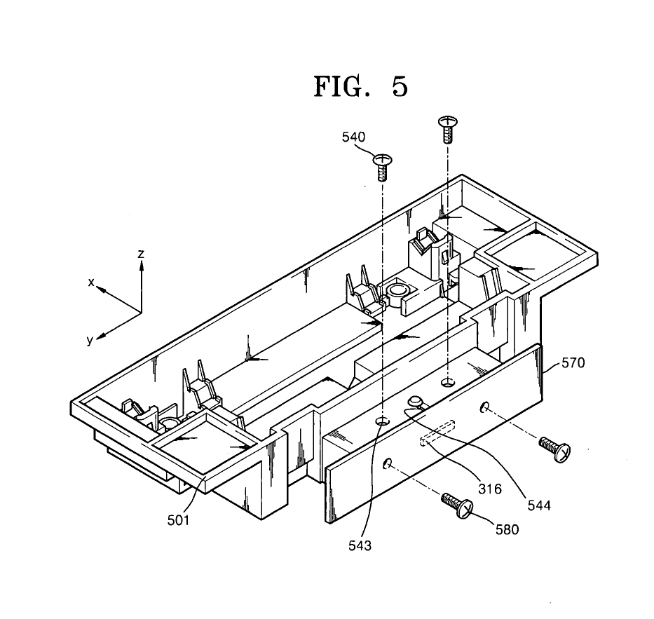

FIG. 3 is a perspective view of a scanning unit 99 according to another embodiment of the present invention. FIG. 4 is a side sectional view of a scanning module 500 according the embodiment of FIG. 3. As shown in FIGS. 3 and 4, the scanning module 500 reads an image from a document S, and the driving module 200 is provided in a body 101 of the image reading apparatus and slides the scanning module 500 in the sub-scanning direction.

In the embodiment of FIG. 4, the illustrated scanning module 500 is formed such that a light source 311, which projects light over a length corresponding to a width of a document S in the main scanning direction, mirrors 314, and a focusing lens 315 are integrally provided in a frame 501. An image sensor 316 is attached to a base plate 570, and the base plate 570 is coupled to an alignment member 550 and integrally assembled to the frame 501.

When a document S to be read is placed on an upper surface of the flat glass panel 51, a light-reflecting member 313 reflects light ejected from the light source 311 in one direction, thereby concentrating the light toward the document S. The light reflected from the document S contains image data of the document S. The light containing the image data is then reflected by the plurality of mirrors 314 toward the focusing lens 315. The focusing lens 315 focuses light incident thereon from the mirrors 314 and sends the focused light to the image sensor 316. As the image sensor 316, a charge coupled device (CCD) sensor that converts light obtained by scanning the document S into an electric signal may be used. Here, a CCD sensor having relatively large resolution and depth of focus may be used in a high-speed and large-sized image reading apparatus that reads a document S of A3 size or larger.

The driving module 200 includes wires 220, wire pulleys 231 and 241, a guide shaft 250, wire pulley shafts 230 and 240, driving pulleys 260 and 262, and a driving motor 263. The wires 220 are coupled to both ends of the scanning module 500 and slide the scanning module 500 in the sub-scanning direction. The wires 220 are provided as a pair of wires, which are wound around the wire pulleys 231 and 241 to be movable thereon. The wire pulleys 231 and 241 are connected to the wire pulley shafts 230 and 240 and move the pair of wires 220 at the same respective speeds. The guide shaft 250 guides a movement of the scanning module 500 in the x direction. The driving pulley 260 is coupled to one of the wire pulley shafts 230 and 240. The driving pulley 260 receives a driving force from the driving motor 263 via a driving belt 261 connected to the driving pulley 262 and transfers the driving force to the wire pulley shaft 230. A guide hole 350 is provided at the scanning module 500, and the guide shaft 250 is inserted in the guide hole 350. The guide hole 350 and the guide shaft 250 guide a linear movement of the scanning module 500.

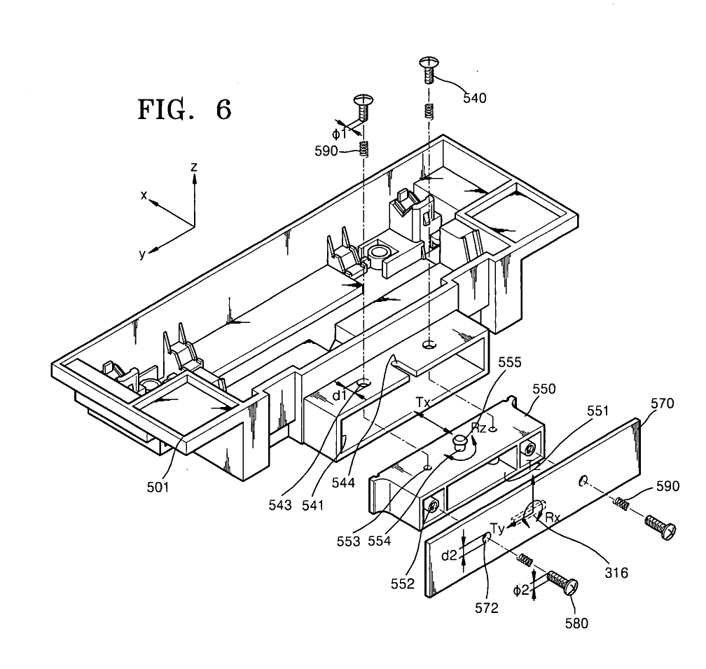

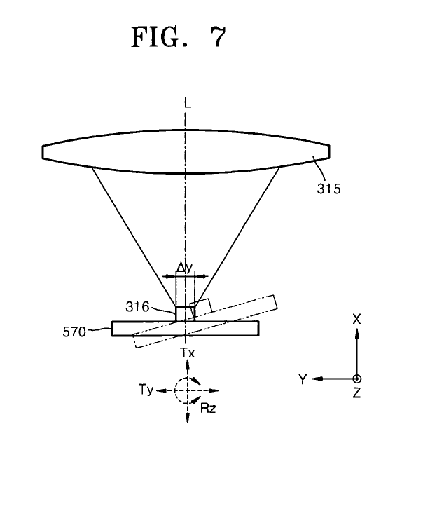

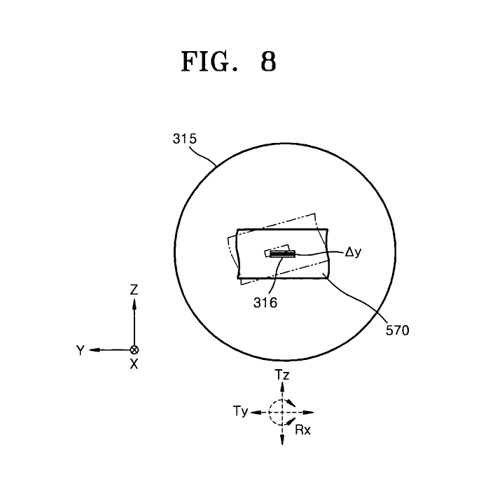

FIG. 5 is an assembled perspective view of a scanning module 500 according to another embodiment of the present invention, FIG. 6 is an exploded perspective view of the scanning module 500, and FIGS. 7 and 8 are views to explain positions and tilt angles of an image sensor according to an embodiment of the present invention. As shown in FIGS. 4 through 8, a base plate 570 to which a frame 501, an alignment member 550 and an image sensor 316 are attached is illustrated. In the frame 501 a light source 311, a mirror 314 and a focusing lens 315 are disposed to form an optical path. The alignment member 550 is disposed between the focusing lens 315 and the base plate 570 along an optical axis L of the focusing lens 315. An alignment unit (not shown) aligns positions and tilt angles of the image sensor 316 with regard to five degrees of freedom in order to maintain an ability to provide high quality reading ability. The alignment member 550 is coupled to the frame 501, and the base plate 570 is coupled to the alignment member 550. The positions and tilt angles of the image sensor 316 are aligned by controlling a coupling position of the alignment member 550 to the frame 501 and by controlling a coupling position of the base plate 570 to the alignment member 550.

Generally, the image sensor 316 has six degrees of freedom with respect to the three orthogonal coordinate axes. That is, the image sensor 316 has three transitional degrees of freedom related to a position thereof in the sub-scanning direction (the x direction), the main scanning direction (the y direction), and the direction perpendicular to a document surface (the z direction), respectively, and three rotational degrees of freedom related to a tilt angle thereof about the three directions.

As mentioned above, the light source 311 emits light of a length corresponding to a width of a document in a direction parallel to the main scanning direction. The light reflected from the document surface passes through a frame aperture 541 that is provided at the frame 501 and an alignment member aperture 551 that is provided at the alignment member 550 via the optical path formed by the mirror 314 and the focusing lens 315, and then is made incident upon the image sensor 316 attached to the base plate 570. As illustrated in FIG. 8, the light incident upon the image sensor 316 has a band shape having a length Δy in the main scanning direction. A similar light spot having a band shape is observable when light emitted from a bar-shaped fluorescent lamp is focused with a lens. Because the light is emitted from the light source 311 having a predetermined length in the main scanning direction and focused by the focusing lens 315, the light has a certain directional property. Therefore, the light is to be precisely projected onto the image sensor 316 in accordance with the positions and tilt angles of the image sensor 316 in order to provide for the accurate reading.

Although the positions and the tilt angles of the image sensor 316 may be aligned with regard to all of six degrees of freedom, to implement this, a very complicated alignment unit and many elements are required. Because tolerance is accumulated as the number of elements being aligned increases, an alignment unit with a complicated structure makes the alignment process even more complicated. Accordingly, an alignment unit according to the present invention aligns the image sensor within a range of five degrees of freedom except for tilting about the y-axis. This is because, in view of the fact that light incident upon the image sensor 316 has a band shape with a length Δy, the tilting of the image sensor 316 about the y-axis has a relatively small effect on directional property of the band shaped light. Also, the tilting of the image sensor 316 about the y-axis hardly affects the reading quality if the image sensor 316 is a line CCD sensor in which each of CCD cells is aligned in a row in the extension direction of Δy.

In the case of a general scanning module 500 having no alignment unit, a base plate 570 is basically provided in order to assemble the image sensor 316 to a frame 501. In the present invention, the image sensor 316 may be precisely aligned over five degrees of freedom by adding only one simple alignment member 550 between the frame 501 and the base plate 507. Although tilting about the y-axis exists as the remaining one degree of freedom which is not an aligning object, the alignment of the tilting about the y-axis may be achieved with a certain acceptable level of error because of a structure of a slot 544 and a hinge head 555 to be described later.

The alignment unit includes a first alignment unit to control a coupling position of the alignment member 550 to the frame 501 and, thus, to align a position of the image sensor 316 in the sub-scanning direction and a tilt thereof about a direction perpendicular to a document surface, and a second alignment unit to control a coupling position of the base plate 570 to the alignment member 550 and, thus, to control a position of the image sensor 316 in the main scanning direction, a position thereof in a direction perpendicular to a document surface and a tilt thereof about the sub-scanning direction.

The first alignment unit includes: a hinge 554, provided at one of the frame 501 and the alignment member 550, to work as a rotation axis of the alignment member 550 rotating around the direction perpendicular to a document surface; a slot 544 of a long hole shape provided at the remaining one of the frame 501 and the alignment member 550, in which the hinge 554 is inserted to be movable in the sub-scanning direction; a first fixing member 540 to fix the alignment member 550 to the frame 501; a first through hole 543 provided at one of the frame 501 and the alignment member 550, through which the first fixing member 540 loosely penetrates; and a first coupling hole 553 provided at the remaining one of the frame 501 and the alignment member 550, to which the first fixing member 540 is coupled.

The second alignment unit includes a second fixing member 580 to fix the base plate 570 to the alignment member 550, a second through hole 552 provided at one of the alignment member 550 and the base plate 570, through which the second fixing member 580 loosely penetrates, and a second coupling hole 552 provided at the remaining one of the alignment member 550 and the base plate 570, to which the second fixing member 580 is coupled.

If a coupling position of the alignment member 550 to the frame 501 is controlled, the position and tilt angle of the image sensor 316 may be aligned over two degrees of freedom. Namely, the position Tx of the image sensor 316 in the sub-scanning direction and the tilting Rz thereof about the direction perpendicular to a document surface may be adjusted. If a coupling position of the base plate 570 to the alignment member 550 is controlled, the position and tilt angle of the image sensor 316 may be adjusted over the remaining three degrees of freedom. In other words, the position Ty of the image sensor 316 in the main scanning direction, the position Tz thereof in the direction perpendicular to a document surface, and the tilt Rx thereof about the sub-scanning direction may each be adjusted.

The frame 501 may include the first through hole 543 and the slot 544. The alignment member 550 includes the hinge 554, the first coupling hole 553 and the second coupling hole 552.

The first fixing member 540 is coupled to the first coupling hole 553. The first fixing member 540 loosely penetrates the first through hole 543, in order to prevent a restriction of a movement of the alignment member 550 from occurring due to interference between the first through hole 543 and the first fixing member 540 when the alignment member 550 makes a translational movement along the x-axis and rotates around the z-axis. Therefore, the size d1 of the first through hole 543 is greater than the diameter φ1 of the first fixing member 540 so as to allow the alignment member 550 to move within an available range.

The second fixing member 580 is coupled to the second coupling hole 552. The second fixing member 580 loosely penetrates the second through hole 572 in order to prevent restriction on a movement of the base plate 570 from occurring due to interference of the second through hole 572 and the second fixing member 580 when the base plate 570 makes a translational movement along the y-axis and along the z-axis and rotates around the x-axis. Therefore, the size d2 of the second through hole 572 is greater than the diameter φ2 of the second fixing member 580 so as to allow the base plate 570 to move within an available range. The first and second through holes 543 and 572 may, in alternate embodiments, be shaped as long holes or may have other similar shapes.

Elastic members 590 may be provided to elastically bias the first and second fixing members 540 and 580 in opposite directions to the coupling directions of the first and second fixing members 540 and 580. The coupling members 590 prevent undesirable random movements of the alignment member 550 and the base plate 570 when the positions and tilt angles of the alignment member 550 and the base plate 570 are controlled during a coupling process of the first and second fixing members 540 and 580. A proper jig may be fabricated and used for the position and tilt angle adjustment.

The slot 544 has a long hole shape with a size that substantially coincides with an outer diameter of the hinge 554 and which is open at one side, thereby facilitating an insertion of the hinge 554. The hinge 554 is inserted in the slot 544 to be linearly movable only in the x direction, thereby allowing the translational movement of the alignment member 550 along the x-axis. The alignment member 550 rotates about the z-axis centered on the hinge 554. The image sensor 316 is completely aligned in two degrees of freedom by a fastening of the first fixing member 540 while the position Tx of the alignment member 550 is adjusted in the x direction and the tilting Rz of the alignment member 550 is adjusted about the z direction. Further, the image sensor 316 is completely aligned in the remaining three degrees of freedom by fastening the second fixing member 580 while adjusting the position Tz of the base plate 570 in the z direction, the position Ty in the y direction, and the tilting about the x-axis.

A hinge head 555 may be provided at an upper end portion of the hinge 554. A size of the hinge head 555 is greater than a diameter of the hinge 554, such that the hinge head 555 contacts an upper surface of the slot 544 and guides the insertion of the hinge 554 while restricting the tilting of the alignment member 550 about the y-axis within a certain range. In other words, the tilting of the image sensor 316 about the y-axis is adjusted with a certain level of error because of the structure of the hinge head 55 and the slot 544. Thus, the time exhausted in adjusting the alignment may be reduced.

As described so far, by the scanning module and the image reading apparatus according to aspects of the present invention, an image sensor may be aligned by a simple structure using one alignment member, regardless of whether or not the production of the scanning module is completed. Accordingly, the alignment process is facilitated, the scanning module may be reused, and manufacturing costs thereof are reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A scanning module comprising:
a frame in which a light source, a mirror and a focusing lens are disposed to form an optical path to read a document;
a base plate to which an image sensor is attached, the image sensor receiving light focused by the focusing lens;
an alignment member disposed between the focusing lens and the base plate; and
an alignment unit to align positions and tilt angles of the image sensor with regard to five degrees of freedom by controlling a coupling position of the alignment member with respect to the frame and a coupling position of the base plate with respect to the alignment member.

2. The scanning module according to claim 1, wherein the alignment unit comprises:
a first alignment unit to align a position of the image sensor in a sub-scanning direction and a tilt angle of the image sensor about a direction perpendicular to a surface of the document by controlling the coupling position of the alignment member to the frame; and
a second alignment unit to align a position of the image sensor in a main scanning direction, a position of the image sensor in the direction perpendicular to the document surface, and a tilt angle of the image sensor about the sub-scanning direction, by controlling the coupling position of the base plate to the alignment member.

3. The scanning module according to claim 2, wherein the first alignment unit comprises:
a hinge provided at one of the frame and the alignment member to allow the alignment member to rotate around the direction perpendicular to the document surface;
a slot provided at the remaining one of the frame and the alignment member, and in which the hinge is inserted to be movable in the sub-scanning direction;
a first fixing member to fix the alignment member to the frame;
a first through hole, provided at one of the frame and the alignment member, through which the first fixing member loosely penetrates; and
a first coupling hole, provided at the remaining one of the frame and the alignment member, to which the first fixing member is coupled.

4. The scanning module according to claim 3, wherein the second alignment unit comprises:
a second fixing member to fix the base plate to the alignment member;
a second through hole, provided at one of the alignment member and the base plate, through which the second fixing member loosely penetrates; and
a second coupling hole, provided at the remaining one of the alignment member and the base plate, to which the second fixing member is coupled.

5. The scanning module according to claim 4, wherein a diameter of the first through hole is greater than a diameter of the first fixing member so as to allow the alignment member to move within an available range therein, and wherein a diameter of the second through hole is greater than a diameter of the second fixing member so as to allow the base plate to move within an available range therein.

6. The scanning module according to claim 5, wherein the alignment unit further comprises an elastic member to elastically bias the first and the second fixing members in opposite directions with respect to coupling directions of the first and second fixing members.

7. An image reading apparatus comprising a scanning unit reading a document using a scanning module, the scanning module comprising:
a frame in which a light source, a mirror and a focusing lens are disposed to form an optical path to read a document;
a base plate to which an image sensor is attached, the image sensor receiving light focused by the focusing lens;
an alignment member disposed between the focusing lens and the base plate; and
an alignment unit to align positions and tilt angles of the image sensor with regard to five degrees of freedom by controlling a coupling position of the alignment member with respect to the frame and a coupling position of the base plate with respect to the alignment member.

8. The image reading apparatus according to claim 7, wherein the alignment unit comprises:
a first alignment unit to align a position of the image sensor in a sub-scanning direction and a tilt angle of the image sensor about a direction perpendicular to a surface of the document by controlling the coupling position of the alignment member to the frame; and
a second alignment unit to align a position of the image sensor in a main scanning direction, a position of the image sensor in the direction perpendicular to the document surface, and a tilt angle of the image sensor about the sub-scanning direction, by controlling the coupling position of the base plate to the alignment member.

9. The image reading apparatus according to claim 8, wherein the first alignment unit comprises:
a hinge provided at one of the frame and the alignment member to allow the alignment member to rotate around the direction perpendicular to the document surface;
a slot provided at the remaining one of the frame and the alignment member, and in which the hinge is inserted to be movable in the sub-scanning direction;
a first fixing member to fix the alignment member to the frame;
a first through hole, provided at one of the frame and the alignment member, through which the first fixing member loosely penetrates; and
a first coupling hole, provided at the remaining one of the frame and the alignment member, to which the first fixing member is coupled.

10. The image reading apparatus according to claim 9, wherein the second alignment unit comprises:
a second fixing member to fix the base plate to the alignment member;
a second through hole, provided at one of the alignment member and the base plate, through which the second fixing member loosely penetrates; and
a second coupling hole, provided at the remaining one of the alignment member and the base plate, to which the second fixing member is coupled.

11. The image reading apparatus according to claim 10, wherein a diameter of the first through hole is greater than a diameter of the first fixing member so as to allow the alignment member to move within an available range therein, and wherein a diameter of the second through hole is greater than a diameter of the second fixing member so as to allow the base plate to move within an available range therein.

12. The image reading apparatus according to claim 11, wherein the alignment unit further comprises an elastic member to elastically bias the first and the second fixing members in opposite directions with respect to coupling directions of the first and second fixing members.

13. A scanning module comprising:
a light emitting body to emit light toward a document and to form an optical path along which the light propagates after being reflected from the document;
a base plate to which an image sensor receiving the reflected light is attached;
an alignment member disposed along the optical path upstream from the base plate; and
an alignment unit to align positions and tilt angles of the image sensor with regard to five degrees of freedom by adjusting a position of the alignment member with respect to the frame and by adjusting a position of the base plate with respect to the alignment member.

14. The scanning module according to claim 13, wherein the alignment unit comprises:
a first alignment unit to align a position of the image sensor in a sub-scanning direction and a tilt angle of the image sensor about a direction perpendicular to a surface of the document; and
a second alignment unit to align a position of the image sensor in a main scanning direction, a position of the image sensor in the direction perpendicular to the document surface, and a tilt angle of the image sensor about the sub-scanning direction.

15. The scanning module according to claim 14, wherein the first alignment unit comprises:
a hinge provided at one of the frame and the alignment member to allow the alignment member to rotate around the direction perpendicular to the document surface;
a slot provided at the remaining one of the frame and the alignment member, and in which the hinge is inserted to be movable in the sub-scanning direction;
a first fixing member to fix the alignment member to the frame;
a first through hole, provided at one of the frame and the alignment member, through which the first fixing member loosely penetrates; and
a first coupling hole, provided at the remaining one of the frame and the alignment member, to which the first fixing member is coupled.

16. The scanning module according to claim 15, wherein the second alignment unit comprises:
a second fixing member to fix the base plate to the alignment member;
a second through hole, provided at one of the alignment member and the base plate, through which the second fixing member loosely penetrates; and
a second coupling hole, provided at the remaining one of the alignment member and the base plate, to which the second fixing member is coupled.

17. The scanning module according to claim 16, wherein a diameter of the first through hole is greater than a diameter of the first fixing member so as to allow the alignment member to move within an available range therein, and wherein a diameter of the second through hole is greater than a diameter of the second fixing member so as to allow the base plate to move within an available range therein.

18. The scanning module according to claim 16, wherein the alignment unit further comprises an elastic member to elastically bias the first and the second fixing members in opposite directions with respect to coupling directions of the first and second fixing members.

19. The scanning module according to claim 13, wherein a sixth degree of freedom of the image sensor may be adjusted independently of the other 5 degrees of freedom.

20. An image forming apparatus to scan images from a document and/or to form images on the document, including a scanning module comprising:
a light emitting body to emit light toward a document and to form an optical path along which the light propagates after being reflected from the document;
a base plate to which an image sensor receiving the reflected light is attached;
an alignment member disposed along the optical path upstream from the base plate; and
an alignment unit to align positions and tilt angles of the image sensor with regard to five degrees of freedom by adjusting a position of the alignment member with respect to the frame and by adjusting a position of the base plate with respect to the alignment member.
